(19) United States
(12) Patent Application Publication
(10) Pub. No.: US 2013/0015963 A1
(43) Pub. Date: Jan. 17, 2013

(54) Person-based Method and Device for Generating Proximity Warnings

(71) Applicants: Peter A. Stegmaier, Ponte Capriasca (CH); Urs M. Rothacher, Thalwil (CH)

(72) Inventors: Peter A. Stegmaier, Ponte Capriasca (CH); Urs M. Rothacher, Thalwil (CH)

(73) Assignee: SAFEMINE AG, Baar (CH)

(21) Appl. No.: 13/515,170

(22) PCT Filed: Dec. 11, 2009
(86) PCT No.: PCT/CH2009/000394

§ 371 Date: Oct. 5, 2012

(51) Int. Cl. B60Q 1/00

(52) U.S. Cl. 340/435

(57) ABSTRACT

Vehicles and other objects (4a, 4b, 4c, 5, 6, 7, 8) in a surface mine (1) are equipped with monitoring devices (12) that communicate by radio in order to detect the risk of collisions. The devices (12) are equipped with GNSS-receivers (15). In addition, persons operating in the area are also equipped with monitoring devices (12′). This allows the devices (12) on the vehicles to detect the presence of pedestrians and to issue alerts if necessary, thereby improving the safety of the system. Advantageously, the devices are integrated in a helmet (30) for best radio reception/transmission and can be powered by means of a solar power supply (32).

### TECHNICAL FIELD

The invention relates to a method and device for generating proximity warnings.

### BACKGROUND ART

Surface mines and similar sites or areas are generally operated by means of a large number of vehicles and staff. Some of the vehicles may be exceedingly large, heavy, and difficult to control.

It has been proposed to use GNSS-devices (GNSS=global navigation satellite system, such as GPS) on board of vehicles and other objects, such as cranes, to generate proximity warnings in order to reduce the risk of collisions between vehicles. Such a system is e.g. described in WO 2004/047047 based on devices mounted to the objects. Each device comprises a GNSS receiver, a control unit deriving positional data using the signal of the GNSS receiver, a radio circuit for wireless exchange of the positional data with the other devices, and an output device for outputting proximity warnings.

Such systems allow the driver of a vehicle to obtain information on some of the obstacles nearby.

### DISCLOSURE OF THE INVENTION

The problem to be solved by the invention is to propose a method and a monitoring device of this type that provides improved safety i.e. for persons in a given area.

This problem is solved by the method and device according to the independent claims.

Accordingly, the method according to the present invention uses a monitoring apparatus comprising a plurality of monitoring devices, with at least part of the monitoring devices comprising a radio circuit and at least some them, usually most of them, also a receiver for a radio based positioning system. According to the invention, at least a first such device is mounted on a vehicle operating in the area to be monitored, while at least a second such device is mounted on a person operating in the area.

This design involves individual persons in the monitoring scheme. At first glance, this may seem surprising because individual persons are generally well aware of their surroundings and therefore may no be in need of such monitoring apparatus. However, by mounting a device of the described type on a person, persons e.g. wearing ear protection can be made aware of dangerous vehicles closeby, drivers in the vehicles are now able to take pedestrians into account, etc.

A monitoring device according to the present invention comprises a radio circuit for emitting a device status dataset containing information on the wearer of the device. In addition, it comprises a receiver for a radio based positioning system, e.g. a GNSS-receiver, in which case the device status dataset contains also data indicative of the current position of the device. Finally, the device is provided with a fastener for attaching the monitoring device to a human body.

### BRIEF DESCRIPTION OF THE DRAWINGS

The invention will be better understood when consideration is given to the following detailed description thereof. Such description makes reference to the annexed drawings, wherein:

FIG. 1 shows a schematic representation of a site under surveillance of a collision warning system,

FIG. 2 is a block diagram of a monitoring device as e.g. mounted on a vehicle,

FIG. 3 shows a monitoring device integrated in a helmet,

FIG. 4 shows a monitoring device integrated in a safety west,

FIG. 5 shows a monitoring device attached to a belt, and

FIG. 6 shows a monitoring device attached to a wristband.

### MODES FOR CARRYING OUT THE INVENTION

### Definitions

A “movable object” is any object that can change and is expected to change its position and/or orientation or configuration in space. It may e.g. be a truck or any other vehicle that moves from place to place and changes its orientation in respect to the general north-south direction, e.g. by steering, or it may be an object positioned at a fixed location but able to rotate about its axis or to change its physical configuration, e.g. by extending an gripper or shovel, in such a manner that the volume of safety space attributed to it varies in significant manner.

The term GNSS stands for “Global Navigation Satellite System” and encompasses all satellite based navigation systems, including GPS and Galileo.

The term “radio based positioning system” stands for a GNSS or for any other type of positioning system using radio signals, such as a pseudolite system.

The term “monitoring apparatus” as used herein designates an assembly of devices distributed over several locations, which devices communicate with each other. Some of the devices are installed on movable objects while others may be installed at fixed locations.

The term “mounting a device to a person” is to be understood as affixing the device to the person in such a manner that the person will carry it without requiring the use of his/her hands. For example, the term expresses that the device is affixed to a piece of clothing or equipment, such as a helmet, that the person is wearing.

The site:

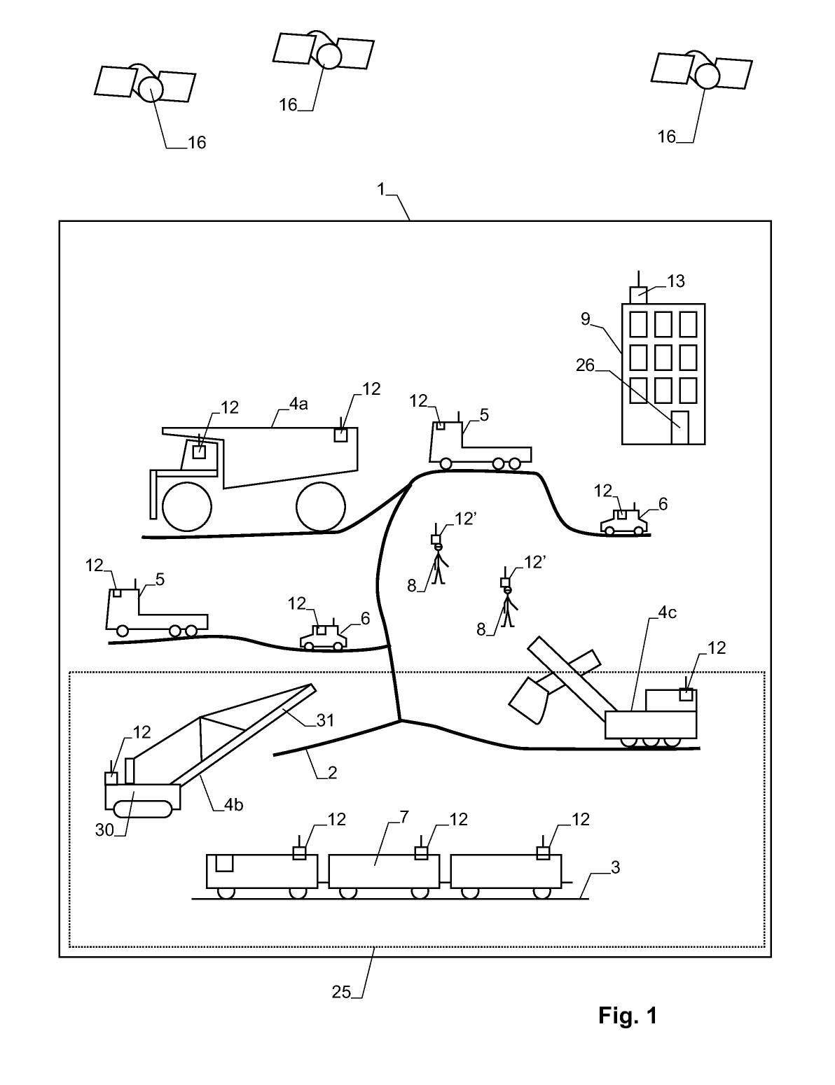

FIG. 1 schematically depicts a site 1, such as a surface mine, to be monitored by the present system. Typically, such a site covers a large area, in the case of a surface mine e.g. in the range of square kilometers, with a network of roads 2 and other traffic ways, such as rails 3. A plurality of objects is present in the mine, such as:
Large vehicles, such as haul trucks 4a, cranes 4b or diggers 4c. Vehicles of this type may easily weigh several 100 tons, and they are generally difficult to control, have very large breaking distances, and a large number of blind spots that the driver is unable to visually monitor without monitoring cameras.
Medium sized vehicles 5, such as regular trucks. These vehicles are easier to control, but they still have several blind spots and require a skilled driver.
Small vehicles 6. Typically, vehicles of this type weigh 3 tons or less. They comprise passenger vehicles and small lorries.
Trains 7.
Individual persons 8, in particular pedestrians.

A further type of object within the mine is comprised of stationary obstacles, such as temporary or permanent buildings 9, open pits, boulders, non-movable excavators, stationary cranes, deposits, etc.

The risk of accidents in such an environment is high, specifically under adverse conditions as bad weather, during night shifts, etc. In particular, the large sized vehicles can easily collide with other vehicles, or obstacles.

For this reason, the mine 1 is equipped with a monitoring apparatus that allows to generate proximity warnings for the personnel of the site, thereby reducing the risk of collisions and accidents.

The monitoring apparatus:

Basically, the monitoring apparatus comprises a plurality of monitoring devices 12. These components communicate in wireless manner, in particular by radio signals. They are described in more detail in the following sections.

In addition, the monitoring apparatus can comprise a central server 13, whose role is explained below.

The monitoring devices:

The monitoring devices 12, 12′ for the proximity warning equipment of the objects and can e.g. be installed on the objects 4-9.

The larger the number of installed monitoring devices 12, the higher the safety level.

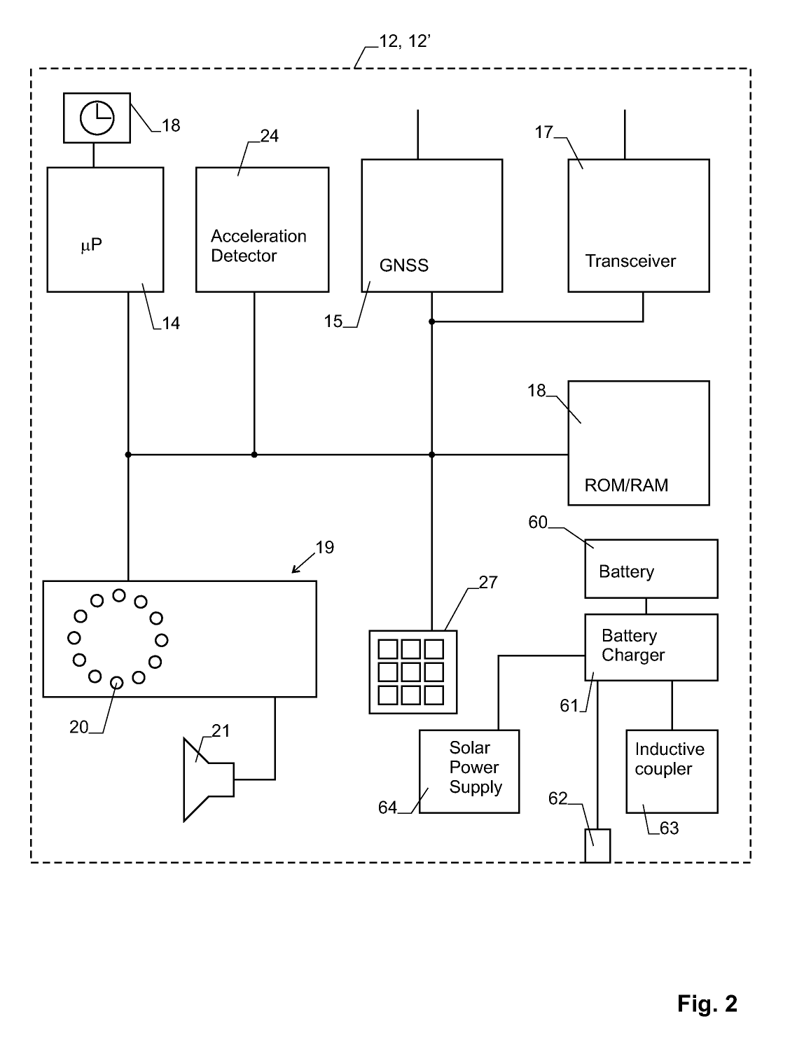

The monitoring device 12, 12′ as shown in FIG. 2 comprises a control unit 14, such as a microprocessor system, which controls the operations of the device.

The monitoring device 12, 12′ further comprises a radio transceiver or circuit 17 for exchanging data with other parts of the monitoring apparatus, e.g. with other monitoring devices 12, 12′.

The monitoring device 12 further may comprise a GNSS receiver 15. Although it is called a GNSS receiver in the following, it can also be a receiver interoperating with any other radio based positioning system for determining its position. The present invention can be used on various types of radio based positioning systems.

Control unit 14 accesses a memory 18 that comprises programs as well as various parameters, such as a unique identifier of the monitoring device.

An output device 19 advantageously comprises an optical display 20 as well as an acoustic signal source 21, such as a loudspeaker.

The primary purpose of monitoring device 12, 12′ is to generate proximity warnings in case that there is a danger of collision. As mentioned in the introduction, this is achieved by receiving at least positional signals through GNSS receiver 15 and exchanging data derived therefrom with other monitoring devices in order to calculate relative positions and probabilities for collisions. The method for calculating relative positions is described in the next section, while further information about various aspects of the monitoring device follows later.

In an advantageous embodiment, device 12 comprises an acceleration detector 24. This acceleration detector 24 can be used to reduce the energy consumption of the device. Since GNSS receiver 15 is one of the major power drains, GNSS receiver 15 can have a “disabled mode” where it is not operating and an “enabled mode” where it is operating. When control unit 14 detects an acceleration by means of acceleration detector 24, it puts GNSS receiver 15 into its enabled state to obtain the current position of the device. Otherwise, it puts GNSS receiver 15, after a predetermined amount of time, into its disabled state. In addition to this, to account for the unlikely event that no acceleration is measured even though the device 12 is moving, control unit 14 can be adapted to put GNSS receiver 15 into its enabled state at regular intervals in order to perform sporadic position measurements.

In addition or alternatively to switching GNSS receiver 15 between a disabled an enabled state, other parts of device 12 can be switched between an idle and an active state in response to signals from acceleration detector 24. In general terms, device 12 can have an “idle state” and an “active sate”, wherein, in said idle state, device 12 has a smaller power consumption than in said active state. Control unit 14 is adapted to put device 12 into its active state upon detection of an acceleration by acceleration detector 24, while the device is e.g. brought back to its inactive state if no acceleration has been detected for a certain period of time.

Device 12 advantageously comprises a rechargeable battery 60 for feeding power to its components. A battery charger 61 comprises circuitry for charging battery 60. Battery charger 61 can draw power from at least one power source. Such power sources can e.g. be
a power plug 62 for directly connecting device 12 to an external power supply;
an inductive coupler 63 comprising a coil adapted to generate electrical current from an alternating magnetic field generated by an external primary coil; such inductive power couplers are known to the skilled person; and/or
a solar power supply 64 mounted at the outer surface of device 12 or in a separate unit electrically connected to device 12.

Relative position determination:

The operation of the monitoring devices can be basically as in conventional systems of this type, such as e.g. described in WO 2004/047047 and need not be described in detail herein.

In short, in a simple approach, each device obtains positional data derived from a signal from GNSS receiver 15. This positional data allows to determine the position of the device and is stored in a “device status dataset”. The device status dataset also contains a unique identifier (i.e. an identifier unique to each of the monitoring devices 12, 12′ used on the same site).

The device status dataset is emitted as a radio signal through transceiver 17. At the same time, the device receives the corresponding signals from neighboring devices and, for each such neighboring device, it calculates the relative distance d by subtracting its own coordinates from those of the neighboring device.

Proximity warnings:

Proximity warnings can be generated by means of various algorithms. Examples of such algorithms are described in the following.

In a very simple approach, it can be tested if the absolute value of the relative distance d is below a given threshold. If yes, a proximity warning can be issued. This corresponds to the assumption that a circular volume in space is reserved for each object. The radius of the circular volume attributed to an object can e.g. be encoded in its device status dataset.

A more accurate algorithm can e.g. take into account not only the relative position, but also the driving velocities and directions of the vehicles.

An improvement of the prediction of collisions can be achieved by storing data indicative of the size and/or shape of the vehicle that a monitoring device is mounted to. This is especially true for large vehicles, which may have non-negligible dimensions. In a most simple embodiment, a vehicle can be modeled to have the same size in all directions, thereby defining a circle/sphere “covered” by the vehicle. If these circles or spheres of two vehicles are predicted to intersect in the near future, a proximity warning can be issued.

Instead of modeling an object or vehicle by a simple circle or sphere, a more refined modeling and therefore proximity prediction can be achieved by storing the shape (i.e. the bounds) of the vehicle in the dataset. In addition, not only the shape of the vehicle, but also the position of the GNSS-receiver 15 (or its antenna) in respect to this shape or bounds can be stored in memory 18.

In addition to the above position based algorithms, also “existence based” approaches can be used: should no positional information be available (no GPS available due to insufficient number of satellites, technical malfunction, etc), the device status dataset contains only information indicative of the type of object the device is attached to, i.e. it indicates if the object is a vehicle, a person, or another type of object, but not its position. As the range of the radio signal is typically limited to some 100 m, the existence of a monitoring device within radio range with unknown position can be detected and appropriate action can be taken.

In some cases, the signal strength of a received radio signal can be used to determine a range of distance where the monitoring device may be, thus improving warning accuracy in such a case. Hence, a first monitoring device receiving a signal from a second monitoring device assesses the signal strength of said signal and generates a proximity warning based on the assessed signal strength, in particular by comparing it to a maximum value. A refined scheme based on signal strength is described below.

Other functions:

In addition to issuing proximity warnings as described above, device 12, 12′ can provide other uses and functions.

In one embodiment, which is particularly useful if device 12, 12′ is worn on a person, the device can issue a warning when it leaves the site or enters a “forbidden area” of the site. This can e.g. happen when a user of the device forgets to return the apparatus when leaving the site or tries to steal it, or when a user enters an area 25, such as a blast area, that is not safe for him.

This type of warning can be generated by executing the following steps:

1) In a first step, control unit 14 obtains the position of the apparatus by means of GNSS receiver 15.

2) In a second step, control unit 14 compares this position to a predefined geographical area. This geographical area can e.g. be stored in memory 18 and describes the area where the device is allowed to be operated. If it is found that the position is not within the geographical area, the following step 3 is executed:

3a) A warning is issued. This warning can e.g. be displayed on display 20 or issued as a sound by acoustic signal source 21.

3b) Alternatively, or in addition to 3a, the warning can be sent, e.g. by means of a cellular phone transceiver integrated into device 12, 12′, to a central monitoring system (i.e. central server 13), together with the current position and identity of the apparatus. Then, the warning can be displayed by central server 13 and brought to the attention of personnel that can then take any necessary steps.

3c) Alternatively, or in addition to 3a and/or 3b, the apparatus can be made unuseable by blocking and/or destroying at least part of its functionality.

In general, a cellular phone network (or any other wireless network) can be used to transmit information from the monitoring devices to central server 13. As mentioned, this information can e.g. comprise any warnings issued by the monitoring devices, and/or it may comprise the position of the monitoring device.

Another application of a cellular phone transceiver integrated in device 12, 12′ is to send messages from central server 13 to any device 12, 12′. Such messages are received by apparatus or device 12, 12′ and displayed on display 20 or replayed by acoustic signal source 21. This e.g. allows to issue warnings, alerts or information to the person using the device.

The monitoring devices can also be used for generating automatic response to the presence of a vehicle or person at a certain location. For example, when a pedestrian with a monitoring device approaches a gate, such as door 26 of building 9, that door can open automatically. Similarly, an entry light can switch to red or to green, depending on the type of object that a monitoring device is attached to, or a boom can open or close. This can be achieved by mounting a receiver device to a selected object (such as a door, a gate, boom or an entry light). The receiver device is equipped with a radio receiver adapted to detect the proximity of monitoring devices. When the receiver device detects the proximity of a monitoring device, it actuates an actuator (such as the door, gate or entry light) after testing access rights of the object attributed to the monitoring device. For example, the actuator may be actuated depending on the type of the object that the monitoring device is attached to. This type is transmitted as part of the device status dataset of the monitoring device.

Furthermore, the control unit of the monitoring device 12, 12′ can have an “alert mode”, which can be activated by a user, e.g. by pressing an alert button on a keyboard 27 and/or by voice control. It can e.g. be used to indicate that the person using the device is in need of urgent help or needs all activity around it to be stopped immediately. The device status dataset comprises a flag indicative of whether the device is in alert mode. Another monitoring device receiving a device status dataset that indicates that the sender is in alert mode may take appropriate action. For example, the central control room operator can be informed, closeby machinery can be shut down, etc.

Persons on the site:

As mentioned above, the devices 12, 12′ are not only mounted to the vehicles in the area, but also to individual persons 8 on the site. In the embodiment illustrated in FIG. 1, the corresponding monitoring devices are marked with reference numeral 12′.

In the following, the monitoring devices mounted to vehicles 4a, 4b, 4c, 5, 6, 7 are termed “first devices” 12, while those mounted to persons 8 are termed “second devices” 12′.

Advantageously, the first and second devices 12, 12a both comprise substantially identical GNSS receivers 15, radio circuits 17 for emitting the device status dataset and control units 14. By using the same type of device for persons as well as vehicles, costs can be reduced.

The first monitoring devices 12 mounted to the vehicles can now cooperate with the second monitoring devices 12′ mounted to the persons in such a manner that

a) the drivers are alerted of the presence of pedestrians, and/or

b) the pedestrians are alerted of the presence of the vehicles.

While option a) is the primary purpose of the present invention, option b) may also have its uses.

In order to alert the drivers of the presence of a pedestrian, each second monitoring device 12′ generates its device status dataset, which will be called the “second device status dataset” in the following, and emits the same through its radio circuit 17. The second device status dataset is now received by some or all of the first monitoring devices 12, thereby allowing the first device to generate a proximity warning based on the mutual position of the first and the second monitoring devices 12, 12′. Such an alert can then be brought to the attention of the driver operating the vehicle.

Similarly, in order to alert a pedestrian of the presence of a vehicle close by, each first monitoring device 12 generates its device status dataset, which will be called the “first device status dataset” in the following, and emits the same through its radio circuit 17. The first device status dataset is now received by some or all of the second monitoring devices 12′, thereby allowing the second device(s) 12′ to generate a proximity warning based on the mutual position of the first and the second monitoring devices 12, 12′. Such an alert can then be brought to the attention of the person wearing the device, e.g. by means of display 20 (if the same can be observed by the person), or the acoustic signal source 21, or an integrated vibrating device, or other signals.

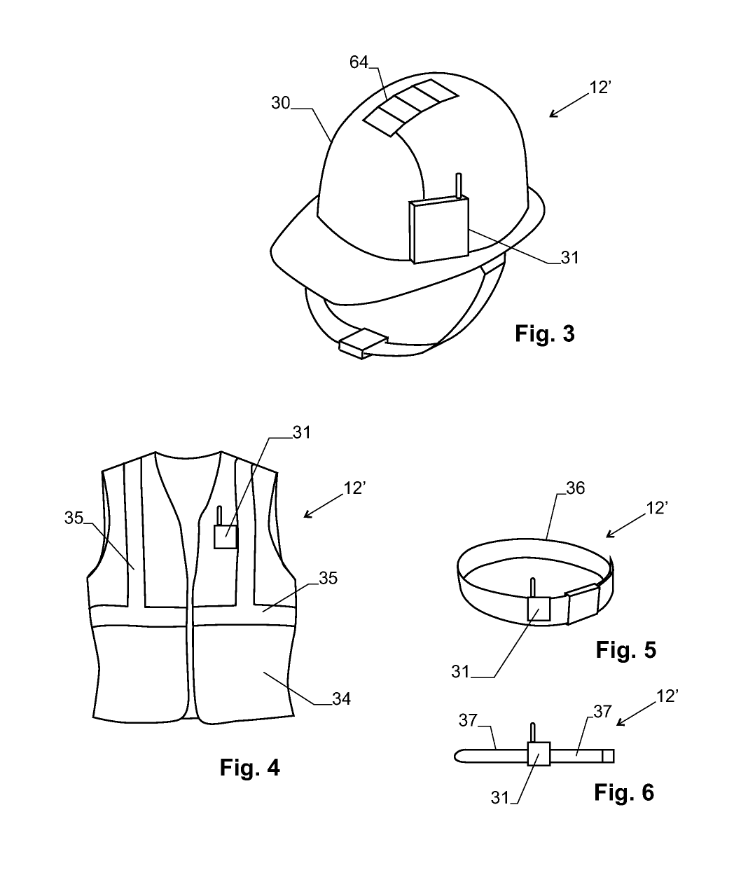

The second monitoring devices 12′ can be “mounted” in various manner to a person. Hence, the devices 12′ must be provided with a suitable fastener for attaching it to a human body. Advantageously, the device can be attached to or integrated into a helmet, a piece of clothing, a wristband or a belt of that person. Examples are shown in FIGS. 3-6.

In the embodiment of FIG. 3, the monitoring device 12′ comprises a helmet 30 (i.e. a hard hat) as “fastener”, such as it is typically carried by persons working in mines, building sites and other dangerous areas. A housing 31 is attached to the helmet 30 for receiving the electronics of the device. Power can be supplied to battery charger 60 e.g. by solar power supply 64 mounted to the top of helmet 30. Integrating the device in a helmet has various advantages. In particular, radio reception is typically better at higher positions. Also, if the device is provided with the solar power supply 32, helmet 30, and in particular the top of helmet 30, provides a good, unobstructed location for mounting the same. Finally, optical or acoustical signals can be emitted close to the user's eyes and ears, respectively.

In the embodiment of FIG. 4, the monitoring device comprises a piece of clothing, in particular a safety vest 34 as “fastener” for mounting it to the human body. Again, a housing 31 is attached to or integrated into vest 34 for receiving the device's electronics. Safety vest 34 is of a type generally known to the skilled person, and is typically provided with optical reflectors 35.

FIG. 5 shows an embodiment of the device where a belt 36 forms the “fastener” to the human body.

FIG. 6 shows an embodiment of the device where the “fastener” is formed by a wristband 37, such that it can be used in a fashion similar to a wristwatch.

Signal strength triangulation:

Under adverse conditions, e.g. when one or more satellite signals are blocked, e.g. by obstacles, GNSS receiver 15 of a given device may not be able to derive its position, or the determined position will be inaccurate. Also, as mentioned, some devices may not be equipped with a GNSS receiver 15 at all.

Therefore, in order to further improve the reliability and versatility of the system, device 12 can be equipped to perform a “signal strength triangulation” as described in the following. This triangulation allows to determine the mutual positions of several devices at least approximately, even if one or more of them is unable to determine its position based on GNSS signals. The principles of this signal strength triangulation are described in the following.

The radio signal emitted by transceiver 17 has a strength S that decays as a function of distance r. This decay can be approximated by a decay function d(r) with

S(r)=S₀·d(r). (1)

For example, d(r) can, in far field approximation, decay with a negative power of r, i.e. d(r)=r⁻ⁿ, with n being 2 or larger.

In the following, it is assumed that a first device A and a second device B know their positions p_{A} and p_{B} and receive a device status dataset with a signal from a third device C. The signal from device C is lacking position information because device C is unable to determine its position p_{C}. However, the first device A is able to measure the signal strength S_{CA} of the signal that it receives from device C, and, similarly, the second device B is able to measure the signal strength S_{CB} that it receives from device C. If the distance between devices A and C is r_{AC} and the distance between devices B and C is r_{BC}, the following set of equations applies:

S_{CA}=S_{0C}·d(|p_{C}−p_{A}|) and

S_{CB}=S_{0C}·d(|p_{C}−p_{B}|), (2)

with S_{0C} being the original signal strength (i.e. the signal strength at zero distance) of device C. Assuming that the vertical coordinates of the positions of all three devices are equal (the devices are on a flat terrain), or assuming that the surface of the terrain is known (i.e. the vertical coordinate of a device is a known function of its horizontal coordinates), and assuming that S_{0C} is known as well, the set of two equations (2) has two unknowns, namely the horizontal coordinates of the position p_{C} of device C. Hence, in that case, the position p_{C} can be basically calculated from the measured signal strengths S_{CA} and S_{CB}. Hence, any device that knows the positions p_{A},p_{B} as well as the signal strengths S_{CA}, S_{CB} measured by the devices A and B, can obtain an estimate of the position p_{C} of device C.

There may, however, be more than one solution to the set of equations (2), and, since the function d(r) will never be able to accurately reproduce the signal decay in arbitrary terrain, the solution of (2) may be inaccurate. To further improve accuracy, it is advantageous to generalize the case to N devices measuring a signal from a “third” device j, in which case the signal strength Sⱼᵢ received by device i from device j is given by

Sⱼᵢ=S₀ⱼ·d(|pⱼ−pᵢ|) (3)

with i=1 . . . N and N>1. The equations (3) can be solved in approximation while minimizing the error in each equation using adjustment calculus, which allows to obtain a more accurate estimate for position pⱼ if N>2, and to allow for variations of S₀ⱼ.

Hence, at least a subset of the devices 12 can be designed to calculate the position pⱼ of a “third” device j if the device j does not deliver its position in its device status dataset. For this purpose, at least some or all of the devices should be adapted to broadcast the identities j and the signal strengths Sⱼᵢ of the signals received from other devices j by including this information in their device status dataset. Advantageously, the device status dataset of a device i includes the identities j and the signal strengths Sⱼᵢ for of all (or at least part of the) devices j that a signal was received from. The identity of the third device j and its signal strength Sⱼᵢ can then be used by any other device for estimating the position pᵢ of device j.

Notes:

In the above examples, the embodiment of FIG. 3 is equipped with a solar power supply. It must be noted, however, that solar power supplies can also be used in connection with any other embodiment of the device.

The solar power supply can be used as an alternative to a battery power supply, in addition to a battery power supply, or, as shown above, for charging a rechargeable battery power supply.

While there are shown and described presently preferred embodiments of the invention, it is to be distinctly understood that the invention is not limited thereto but may be otherwise variously embodied and practiced within the scope of the following claims.

1. A method for generating proximity warnings on an area by means of a monitoring apparatus comprising a plurality of monitoring devices, wherein at least part of said monitoring devices comprise a radio circuit and at least some of said monitoring devices also comprise a receiver for a radio based positioning system, said method comprising the steps of
mounting at least a first of said monitoring devices on a vehicle operating in said area, and
mounting at least a second of said monitoring devices on a person operating in said area.

2. The method of claim 1 further comprising the steps of
generating, by means of said second monitoring device, a second device status dataset not containing a position of said second monitoring device, but containing information indicative that said second device is attached to a person, and emitting said second device status dataset through the radio circuit of said second monitoring device,
receiving, by means of said first monitoring device, said second device status dataset, and
generating a proximity warning based on the existence of said second monitoring device.

3. The method of claim 2 further comprising the steps of
assessing a signal strength of a signal from said second monitoring device by the first monitoring device and,
generating a proximity warning based on the assessed signal strength, in particular by comparing said signal strength to a maximum value.

4. The method of claim 1 further comprising the steps of
generating, by means of said second monitoring device, a second device status dataset depending on a position of said second monitoring device, and emitting said second device status dataset through the radio circuit of said second monitoring device,
receiving, by means of said first monitoring device, said second device status dataset, and
generating a proximity warning based on a mutual position of said first and said second monitoring devices.

5. The method of claim 1 comprising the steps of
generating, by means of said first monitoring device, a first device status dataset depending on a position of said first monitoring device, and emitting said first device status dataset through the radio circuit of said first monitoring device,
receiving, by means of said second monitoring device, said first device status dataset, and
generating a proximity warning based on a mutual position of said first and said second monitoring devices.

6. The method of claim 1 wherein said second monitoring device is attached to or integrated into a helmet of said person.

7. The method of claim 1 wherein said second monitoring device is attached to or integrated into a piece of clothing, a wristband or a belt of said person.

8. The method of claim 1 comprising the steps of
obtaining a position of said monitoring device by means of said receiver,
comparing said position to a predefined geographical area and, if said position is not within said predefined geographical area, further comprising the step of
issuing at least one warning message.

9. The method of claim 1, wherein at least one receiver device is located at an actuator in said area, wherein, if said receiver device detects a proximity of one of said monitoring devices, it actuates said actuator after testing access rights of an object attributed to said monitoring device.

10. The method of claim 1 wherein any warning messages issued by said monitoring devices are transmitted to a central monitoring system.

11. The method of claim 1 comprising the step of transmitting a position of at least part of said monitoring devices to a central server.

12. The method of claim 1 comprising the steps of
measuring, by at least a subset of said monitoring devices, a signal strength (Sⱼᵢ) of a signal received from a third monitoring device, and
transmitting, by at least said subset of said monitoring devices, an identity (j) of said third monitoring device and said signal strength (Sⱼᵢ),
receiving said identity (j) and said signal strength (Sⱼᵢ) by one of said monitoring devices and estimating a position of said third monitoring device therefrom.

13. A monitoring device, in particular for being used in the method of claim 1, said monitoring device comprising,
a radio circuit for emitting a device status dataset depending on a position of said monitoring device,
a control unit adapted and structured to generate a proximity alert, and
a fastener for attaching said monitoring device to a human body.

14. The device of claim 13 wherein said device status dataset includes information that the monitoring device is attached to a person.

15. The device of claim 13 further comprising a receiver for a radio based positioning system.

16. The device of claim 13 comprising a solar power supply.

17. The device of claim 16 comprising a helmet, wherein said solar power supply is mounted to helmet.

18. The device of claim 13 wherein said fastener comprises a helmet.

19. The device of claim 13 wherein said fastener comprises a belt or a wristband.

20. The device of claim 13 wherein said fastener comprises a vest, in particular a safety vest with optical reflectors.

21. The device of claim 13 wherein said control unit is adapted and structured to have an alert mode that can be activated by a user of said monitoring device, and wherein said device status dataset comprises a flag indicative of whether said device is in said alert mode.

22. The device of claim 13 comprising at least one rechargeable battery and an inductive coupler for inductively coupling energy into said battery.

23. The device of claim 13 having an idle state and an active sate, wherein, in said idle state, said device has a smaller power consumption than in said active state, said device further comprising an acceleration detector, wherein said control unit is adapted to put said device into said active state upon detection of an acceleration by said acceleration detector,
and in particular wherein said device further comprises a receiver for a radio based positioning system which is disabled in said idle state and operating in said active state.

24. The method of claim 1 comprising steps of
obtaining a position of said first of said monitoring devices by means of said receiver,
storing said position of said first of said monitoring devices in a first device status dataset of said first of said monitoring devices, wherein said first device status dataset comprises a unique identifier of said first of said monitoring devices, and
transmitting said first device status dataset as a radio signal by means of said radio circuit.

25. The method of claim 24 further comprising steps of
receiving by means of said radio circuit of said first of said monitoring devices a second device status dataset of said second of said monitoring devices, wherein said second device status dataset comprises a position of said second of said monitoring devices, and
calculating a distance (d) between said first of said monitoring devices and said second of said monitoring devices using said position of said first of said monitoring devices and using said second device status dataset.
